(19) United States
(12) Patent Application Publication
(10) Pub. No.: US 2004/0176025 A1
(43) Pub. Date: Sep. 9, 2004

(54) Playing music with mobile phones

(75) Inventors: Jukka Holm, Tampere (FI); Pauli Laine, Espoo (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/360,214

(22) Filed: Feb. 7, 2003

(51) Int. Cl. H04H 7/00

(52) U.S. Cl. 455/3.06; 455/412.1

(57) ABSTRACT

Mobile telephones, personal digital assistants or other small portable computing devices are used to play music either transmitted from a content provider or stored in the device. A number of options are provided that enable the user, even with limited musical ability, to modify the music, both in a solo playing mode and in an ensemble jamming mode. A Master Computer runs a program to play the music and synchronizing the playing. The program may also assign parts to the members of the group.

### TECHNICAL FIELD

The field of the invention is mobile telephony, in particular entertainment applications involving playing and improvising music using mobile telephones as instruments.

### BACKGROUND OF THE INVENTION

A standard protocol for the storage and transmission of sound information is the MIDI (Musical Instrument Digital Interface) system, specified by MIDI Manufacturers Association. The invention is discussed in the context of MIDI for convenience because that is a well known, commercially available standard. Other standards could be used instead, and the invention is not confined to MIDI.

A Network Musical Performance (NMP) occurs when a group of musicians, located at different physical locations, interact over a network to perform as they would if located in the same room. Reference in this regard can be had to a publication entitled “A Case for Network Musical Performance”, J. Lazzaro and J. Wawrzynek, NOSSDAV'01, Jun. 25-26, 2001, Port Jefferson, N.Y., USA. These authors describe the use of a client/server architecture employing the IETF Real Time Protocol (RTP) to exchange audio streams by packet transmissions over a network. Related to this publication is another publication: “The MIDI Wire Protocol Packetization (MWPP)”, also by J. Lazzaro and J. Wawrzynek, http://www.ietf.org/internet-drafts/draft-ietf-avt-mwpp-midi-rtp-02.txt, Internet Draft, Feb. 28, 2002 (expires Aug. 28, 2002).

### SUMMARY OF THE INVENTION

The invention relates to apparatus and methods for playing music with modifications provided by the user.

A feature of the invention is joint playing of music on electronic computing devices by a number of users under control of a Master Computer that assigns parts to Slave Computers, where at least the Slave Computers play instrumental voices.

A feature of the invention is computer-assisted modification of stored musical files.

Another feature of the invention is synchronization by a Master Computer of Slave Computers, all playing the same musical composition.

### BRIEF DESCRIPTION OF THE DRAWING

The foregoing and other aspects of these teachings are made more evident in the following Detailed Description of the Preferred Embodiments, when read in conjunction with the attached Drawing Figures, wherein:

FIG. 1 is a high level block diagram showing a wireless communication network comprised of a plurality of MIDI devices, such as one or more sources and one or more MIDI units, such as a synthesizer;

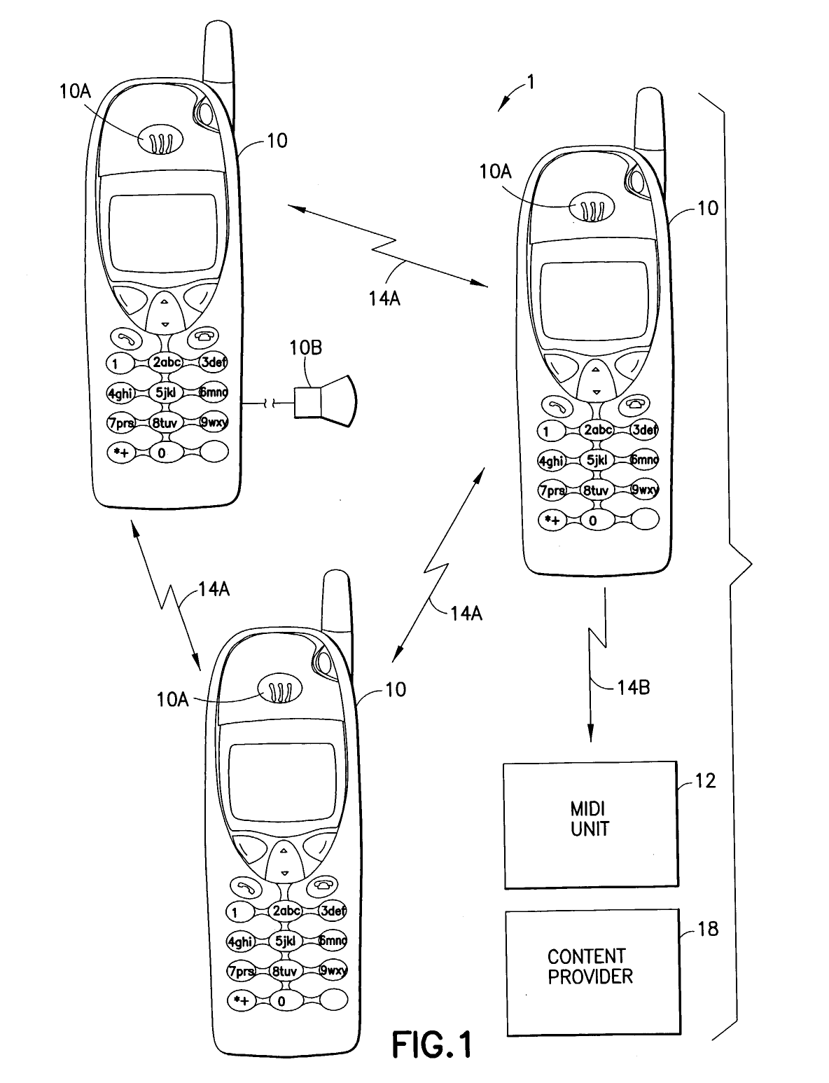

FIG. 2 is a simplified block diagram in accordance with this invention showing two of the sources from FIG. 1 that are MIDI enabled;

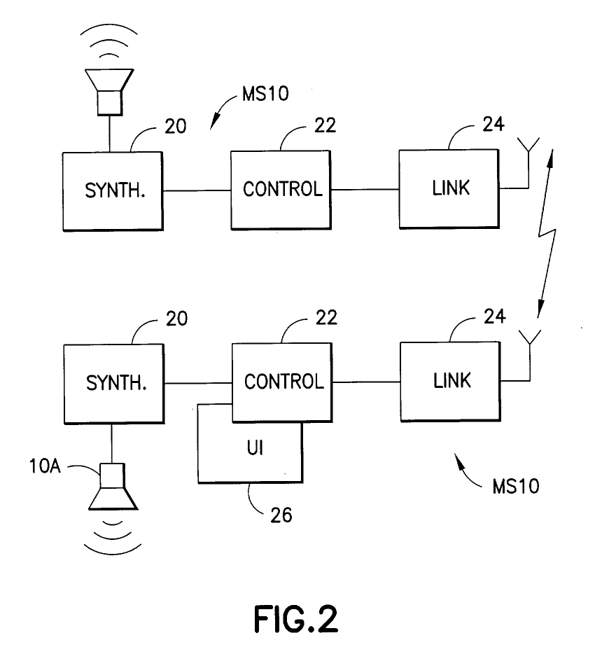

FIG. 3 is an exemplary state diagram illustrating the setting of IDs when one device acts as a master device; and

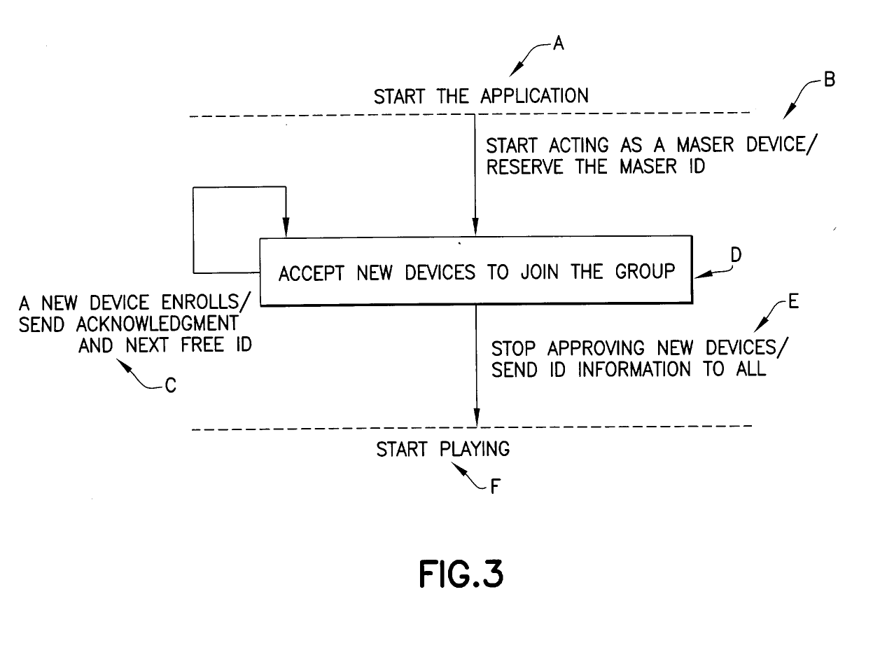

FIG. 4 shows a block level diagram of a mobile station.

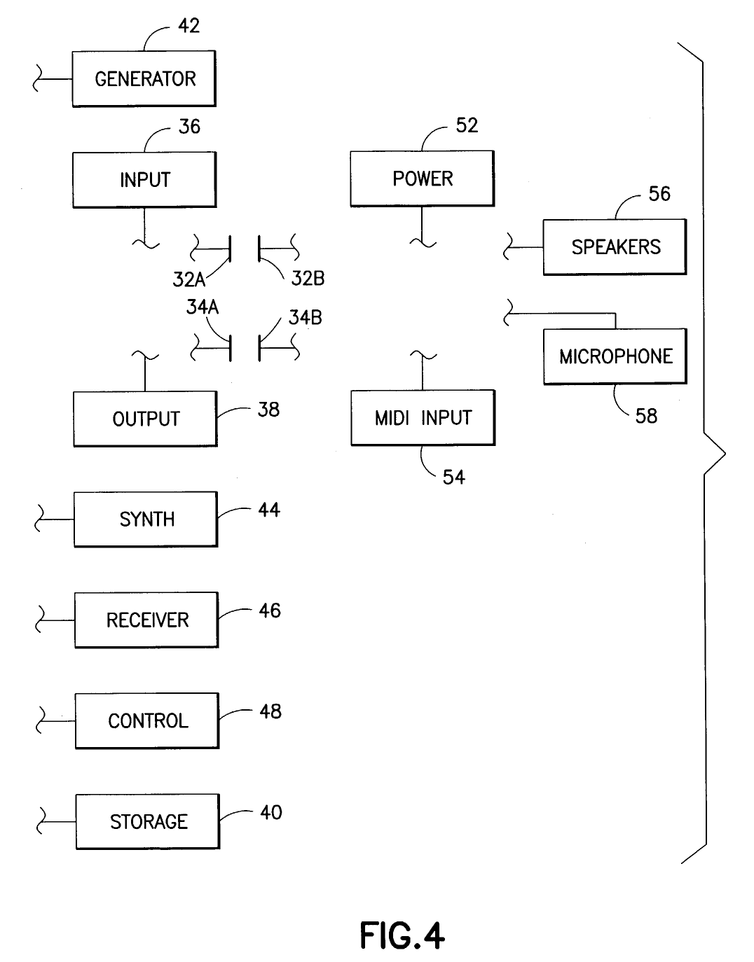

FIG. 5 illustrates the sequence of initializing solo playing according to the invention.

FIG. 6 illustrates the sequence of forming a new band.

FIG. 7 illustrates the sequence of joining an existing band.

### BEST MODE OF CARRYING OUT THE INVENTION

The following section describes an application in which users are able to play melodies, rhythms, loops, etc. in real-time using a mobile phone or other small portable terminal (referred to generally as a computer device) and the terminal's keypad or other MIDI controllers.

The mobile terminal acts as a musical instrument that features a new level of musical interaction and enjoyment where no musical knowledge is required in order to generate pleasant sounding music. Examples of concepts and applications include, for example, jamming and interactive composition.

In one example, a group of users heard a recorded samba MIDI track through their headphones and were able to jam along by shaking a mobile phone terminal. Shaking created a percussion sound that was accomplished by inserting an accelerometer inside the terminal and by converting the output signal to MIDI.

In a traditional jamming situation, there are a group of players playing acoustic and/or synthetic instruments in the same space. In this electronic MIDI based version, the players are also located in the same space but are using their mobile phones as instruments. User's operations during the jamming session depend largely on the properties of the phone and the installed jamming applications. The term “applications” as used herein means software that permits varying the music. Varying the music can include, for example, providing musical effects, rhythm patterns, the sounds of different instruments (i.e.: trumpet, sax, bass, etc.) or MIDI files that can be played to make the variations (i.e.: different drum tracks).

In order to further improve the entertainment value of MIDI Jamming, the user should be able to use several applications together.

One important feature of MIDI Jamming is that the playing can be computer assisted. This way the limitations caused by the small display and keypad can be overcome, and also non-musical people are able to join the jamming sessions.

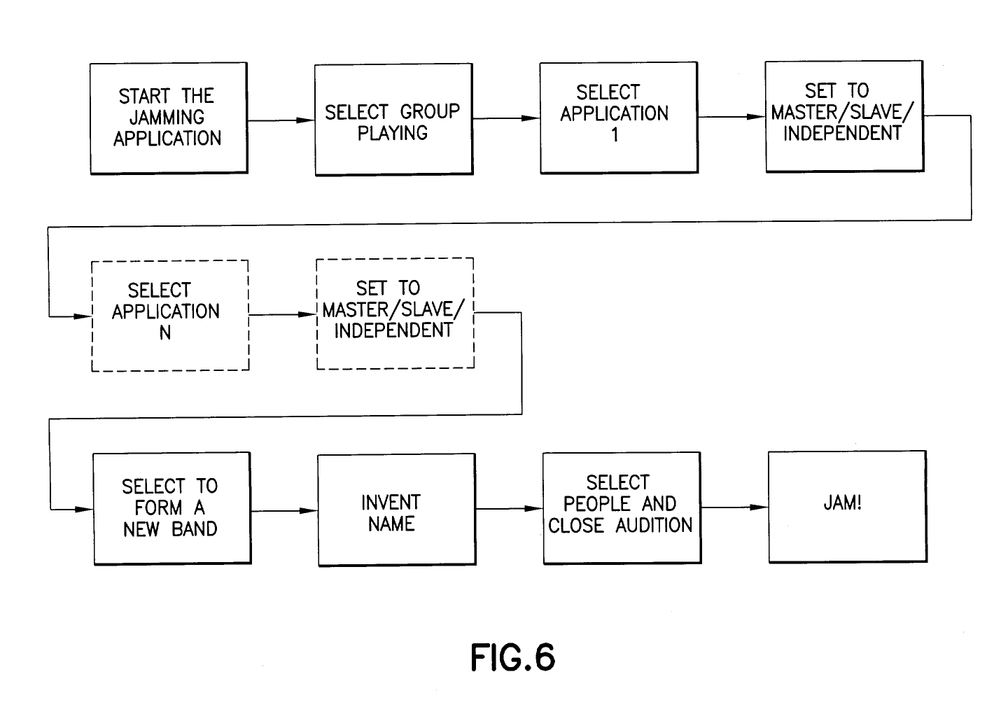

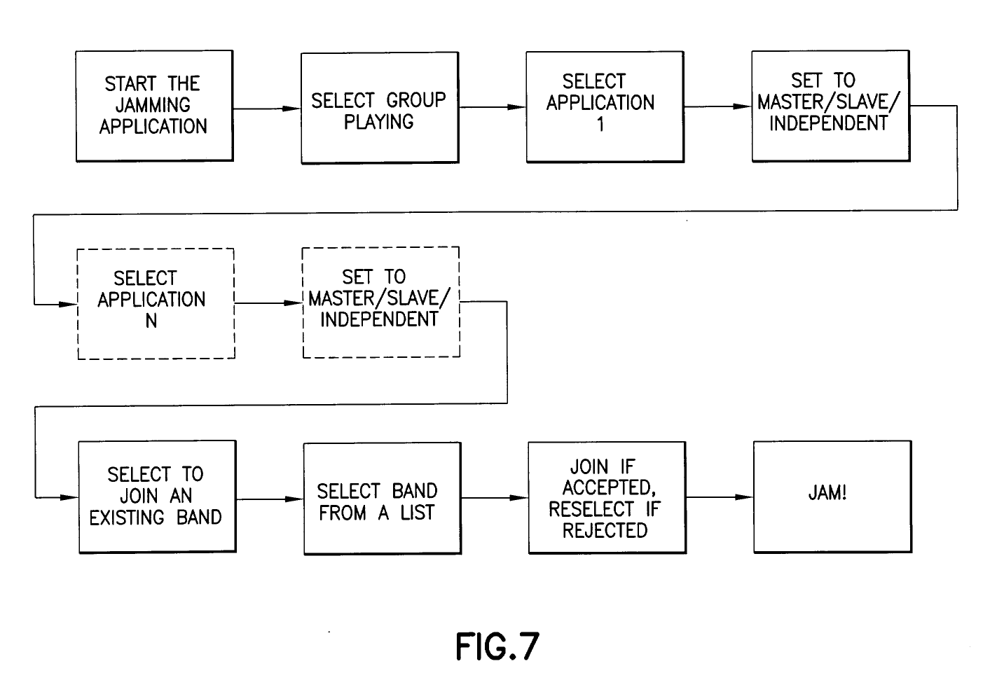

The initialization phase of a MIDI Jamming session goes as follows: After deciding whether to jam alone or in a group, the user then selects the applications to use. The selection of whether to join a group or form a new group can be done either after selecting the applications (like in FIGS. 6 and 7) or immediately after selecting the group playing mode. Before a group jamming session can begin, it is necessary to establish a connection between the jamming devices in order to enable their synchronization and communication. The potential connectivity mechanisms include at least the following: Infrared, Internet, cable, and Bluetooth. In traditional jamming situations, the musicians listen to what is being played and adjust their own playing accordingly. In MIDI Jamming, on the other hand, different terminals/applications rely on synchronizing signals to ensure that they each play their sequences etc. at the same time. Each device is locked together in time so that the entire ensemble of devices functions as a single system. One application acts as a Master Application, to which the Slaves automatically and continuously match their timing. In addition to tempo, different terminals and applications may have to be synchronized both harmony-wise and on some higher musical level. Master Terminal's Master Application is responsible for sending this information globally to the other applications at the right time instants. Throughout this document, we call this kind of synchronization ‘structural synchronization’ or ‘Structural Sync.’

“Independent playing” means that the mobile terminal is played much like a traditional musical instrument. The musical output depends solely on the talent of the user as well as the available sensors and input devices. A simple example is the use of the mobile terminal's keypad to play some notes. In addition to the basic keypad, for example, joysticks, accelerometers and touch screens could be used.

The term ‘assisted playing’ refers to software applications that quantize, correct and/or somehow enhance the musical input given by the user. With this assistance, non-musical users are able to generate some decent sounding music as the applications give the users an illusion of playing better than they actually do. On the other hand, from a musical users' point of view, the difficulties caused by input devices that are not specifically oriented toward playing music, such as the keypad, can be minimized.

When the display size is very limited, it is quite difficult to control the harmonic information. For some users, it may also be difficult to construct harmonic sequences, as that requires some musical knowledge.

Applications are available on commercial synthesizers to generate chords automatically and otherwise assist the player with limited musical skills. A keypad, joystick, or some other such input device may be used to control a similar application for a mobile system.

One of the most common musical things to do is to tap something in the rhythm of music.

Application are available on synthesizers to generate the sounds of various instruments such as drums. In addition, stored music to which the user can add his playing has long been available.

As the computational and memory resources of mobile terminals increase, content providers or other vendors may choose to add some “effects” (i.e.: reverberation, chorus, etc).

The applications may be either terminal specific or installed to every participating terminal. In the latter case, one member could be responsible for generating suitable effects for the whole jamming session. His selections would be sent to each participant's terminal and reproduced there by that terminal's effects software.

The most straightforward solution would be to let the user just select if a certain preset effect is on or off. The selection could happen in the beginning of a jamming session or during it. However, a much more interesting alternative from the user's point of view is to change the effects parameters in real-time.

In the following discussion, the term ‘Tracker’ is used to refer to applications that are based on modifying pre-composed background tracks. Examples include turning on or off stored tracks that each have different instruments playing the same music, altering the tempo of the pre-composed background track, adding an instrument track to a background solo track, etc.

Musically the simplest version of the Tracker is quite limited, but the Tracker may be enjoyable to play especially when the application is refreshed using additional downloadable tracks.

In one example, the user is able to turn on and off melodies, bass lines, and drum patterns by pressing the keys of a mobile phone keypad or a basic PC keyboard. The composer of such content will assemble a set of compatible variations on the basic melody, together with the bass and drums, so that the user cannot go too far wrong. Other alternatives would include e.g. the use of a touch screen.

When a user is playing alone, he does not have to jam over a static loop but can modify the background music to some extent. In group jamming sessions, the first player could be given control over the bass line, the second one over the drums and the third one over the melody. Alternatively, only one player may be responsible for generating all the background music.

When the user starts the MIDI Jamming application, he first has to select between Solo and Group playing modes. These modes vary from each other in some respects so they are discussed separately in the following.

Solo Playing

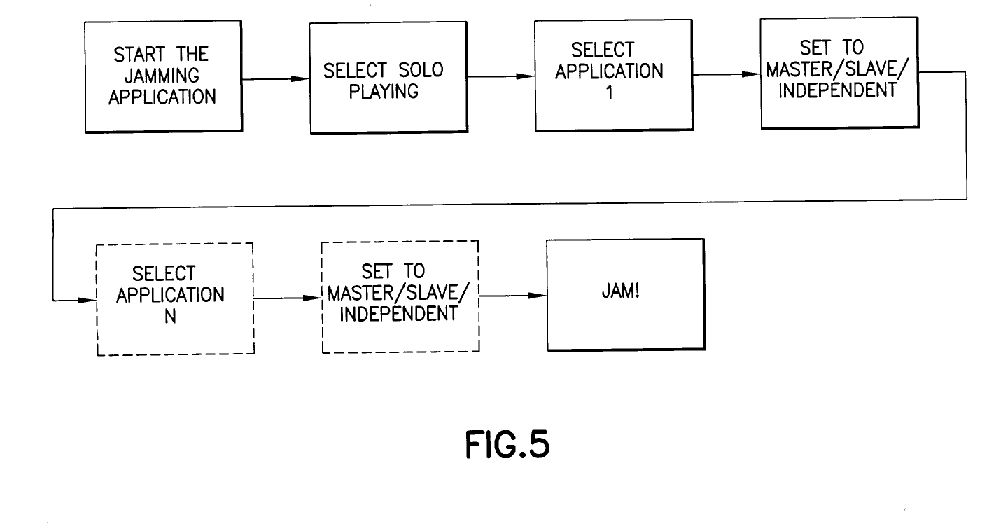

If the Solo playing mode is selected, see FIG. 5, the user sees a list of MIDI Jamming compatible applications, meaning instruments and “effects” that are currently installed on his terminal. After selecting the applications (e.g. the instrument or instruments) he wants to play, the role of each application is defined either manually by the user or automatically by a pre-determined protocol. Possible alternatives include Master, Slave and Independent. Some applications may have fixed roles that cannot be changed.

The Master application (Note that only one application can be set as Master) determines the master tempo, harmony, and so on. All the relevant information is sent to the Slave Applications, which are automatically synchronized to the Master in these respects. Independent applications are not controlled by the information distributed by the Master. The user of an Independent application has complete discretion to use or ignore information from the Master. Thus each Slave must be synchronized to one Master. An Independent application may play without a Master being designated, or may play along with a Master without necessarily being synchronized to it. After all the selections are done and the applications have been synchronized automatically, the actual jamming can begin.

Group Playing

The Group playing mode is more complicated, since N applications and M mobile terminals must potentially be synchronized together both in tempo and harmony as well as on a higher musical level. The Master Application of one terminal (‘Master Terminal’) has to control the Slave Applications of other terminals as well.

Initially, the user sees a list of MIDI Jamming compatible applications that are currently installed to his terminal. After selecting the applications (e.g. the instrument or instruments) he wants to play, the role of each application is defined, either manually by the user or automatically by a pre-determined protocol. Possible alternatives include Master, Slave, and Independent, as in the case of Solo playing. Some applications may have fixed roles that cannot be changed.

The next step is to decide if he wants to form his own “band” or join an existing band. If a new band is formed, the selected Master Application will also be the Master to all mobile terminals joining the group.

Forming a New Band

The simplest example of band formation is a group of users who have agreed to play together, e.g. in a face to face meeting or other communication outside the relevant network. Other versions of band formation are diagramed in FIG. 6. After (optionally) inventing the name of the band, the Master Terminal starts to “look around” for other possible participants. This can be accomplished via Bluetooth or some other connectivity mechanism such as an Internet chat room or some similar multi-user communication provided on a network by a content provider. If there are willing musicians in the neighborhood (i.e.: people who have selected to join an existing band), a list of them is shown on the Master Terminal's screen. As in real-life auditions, the bandleader can accept or reject the people who want to join his band. Each approved terminal is automatically given an ID, using which the connectivity mechanism can track which terminals in the neighborhood belong to that band. When a suitable number of people have been found, the Master can close the “audition” for the jamming session so that nobody can join the band after that time. After all the selections are done and the terminals have been synchronized automatically, the actual jamming can begin.

Joining an Existing Band

If a new user wants to join an existing band, see FIG. 7, the terminal starts to look around for available bands; e.g. by dialing a telephone number that connects to a content provider's computer. The list of bands that are “auditioning” musicians is shown on the terminal screen. In order to join an existing band, the new user must not have any of his applications set to Master. The user may set a selected application to Master, Slave or Independent because at those blocks of FIG. 7, the user has not yet informed the software whether he wants to form a group or join one. However, if some application is set to Master, it will become a Slave to the existing band's Master Terminal Master Application because a jamming session can have only one Master. If some bandleader rejects the new user's application, the new user can still try joining the other bands. When a positive answer has been received, the new user still has to wait until the corresponding Master Terminal has closed the audition. After the terminals have been synchronized automatically, the actual jamming can begin.

Sound Output Options

One important practical aspect of the Group playing mode is whether the sound comes from headphones or from loudspeakers. If headphones are used, all the participants would have to have the same applications installed and running in order to hear what the other ones are playing. If somebody does not have all the applications installed or does not open them, he is not able to hear what everybody else is playing.

Note that if the terminal is required to generate the sounds from the other players also, the consumption of voices (and computing resources) increases radically. This may generate problems especially in low-end phones that do not have much computational power. For those situations some kind of voice playing priority order may be needed. Either Master Terminal's voices or voices generated by user's own terminal can be considered the most important. After that, the other players can be prioritized, according to player ID for example. Another possibility is to give the highest priority to the drum track regardless of the player, as a common pulse makes group playing much easier.

Let us next imagine a situation where all band members have decent loudspeakers and the playing environment is acoustically suitable (and the players are within earshot of one another). In this case, each terminal's sounds could be played through only its own loudspeakers. Terminals could have different applications installed and running as long as they are in sync with each other. This situation resembles closely a real band where each player has his own amplifier. For example, the choice of musical instruments replicated by each terminal can be based on verbal negotiations between the participants, or can be directed electronically by the Master Terminal. One participant could e.g. take care of the bass line, the next one could play drums and so on. When multiple devices are used to create a common sound world, some interesting panning effects etc. can alternatively be produced.

Connectivity Mechanisms

As noted above, there are a variety of means by which multiple terminals may play together. Infrared limits the amount of participants to two and the operating distance is very short. The benefit of IR is that the initialization phase should get simpler: the terminal does not have to look for multiple participants, IDs are not required in the same sense etc. Bluetooth has most of the advantages of infrared, with the further advantage of being able to include more than two participants. A cable-connected LAN limits the freedom of movement of the players.

A significant disadvantage of Internet, and other networks as a connectivity mechanism for remote players is the lack of social contact. Part of the enjoyment of MIDI Jamming comes from seeing the other participants, making gestures, reacting verbally to the session's outcome and so on. The terminals could also be connected via USB, some kind of cable or other accessory.

The need for synchronization between different terminals or inside a single terminal depends on the nature of individual applications. As an example of solo playing, let us consider a case where the user is playing MIDI percussions over some background music using the terminal. The user has to select the background music and after that possibly the percussion instrument. If these were Independent applications, any kind of data transfer or co-operation between the applications would not be needed due to their independent nature. Another example could be a situation where the user is triggering pre-composed drum loops over a background MIDI file. In order to play in the same tempo, some kind of synchronization between the triggering application and the sequencer/Tracker would be needed. If the loops were harmonic sequences instead of drums, a higher-level synchronization mechanism would be needed.

It is assumed the some kind of connection (e.g. Bluetooth) between the terminals is already available, IDs have been given automatically, and that the delay of the connection is musically irrelevant.

In traditional jamming situations, the musicians listen to what is being played and adjust their own playing according to that. In MIDI Jamming, on the other hand, different terminals/applications have to rely on synchronization to ensure that each they play their sequences etc. at the same time. Each (the player of an independent device may choose to be linked if the software permits) device is locked together in time so that the entire ensemble of devices functions as a single system. One application has to act as a Master Application, based on which the Slaves automatically and continuously match their timing. Various methods of synchronization are available in the art and may be used with the invention.

Structural Synchronization

In addition to tempo, different terminals and applications may have to be synchronized both harmony-wise and on some higher musical level. The Master Terminal's Master application is responsible for sending this information globally to the other applications at the right time. Structural synchronization may also be needed in the Solo playing mode if multiple applications are used. From now on, we refer to all this global or application specific information using the term “Structural Sync”. Structural Sync information may e.g. include the starting position of the pieces, harmonic sequences, and so on.

Different possibilities to share the Structural Sync information among different terminals and applications include, for example: Standard MIDI File (SMF) meta-data; MIDI System Exclusive Real Time messages; MIDI General Purpose Controllers (LSB and MSB); and MIDI Non-Registered Parameter Number (LSB and MSB). If the applications used are based on SMF files SMF meta-data events can be used to embed the Structural Sync information inside the file, although this restricts the use considerably and is not preferred. Another possibility is to use real-time System Exclusive messages. Their main advantage is that they have a device ID incorporated.

Implementation

The following list includes some information that is considered useful for Structural Sync in a multi-user multi-application system. Early commercial jamming implementations will probably employ a simpler version.

1) General

a. Application selection

b. Rhythmic quantization type

“Application selection” refers to the application (instrument, musical effects, etc), that is selected in each terminal. This information should be distributed among the participants at least if headphones are used. (Otherwise they would not be able to generate all the sounds of the jamming session.) Alternatively, if the band members are located in the same space, they can decide together which applications to use before forming the band. “Rhythmic quantization type” refers to various modifications of the rhythm track.

2) Scale Information

a. Scale root

b. Scale type

“Scale root” simply refers to the name of the first note of the scale (e.g. C-Major) and “Scale type” to the type (C-Major). There may be many different types available (major, minor, pentatonic, whole note, chromatic, etc), so in certain instances the table from which the scale type is selected may have to be defined on a case by case basis.

3) Harmony Information

a. Chord root

b. Chord type

“Chord root” refers to the tonic of the chord i.e. the keynote or basic tone in a chord (i.e.: C in C-Major chord).

“Chord type” refers to the various chord types (Major, minor, 7th, Maj7th, diminished etc.) Like the scale type table, the table from which the chord type is selected may have to be defined on a case by case basis. The default is that the Master Terminal decides or chooses the chords.

Although the invention has been described with respect to a limited number of embodiments, those skilled in the art will appreciate that other embodiments may be constructed within the spirit and scope of the following claims.

We claim:

1. A method of playing by a group of users using a group of electronic computer devices a modified musical composition by a group of at least two users comprising the steps of:
initiating by a first user using a Master computer device a group playing program;
selecting an instrumental set of instrumental voices for playing;
selecting a set of player computer devices for playing said set of instrumental voices;
assigning the status of Slave computer to at least one of said set of player computer devices;
connecting said Master computer devices and said Slave computer devices by an electronic link;
assigning said set of instrumental voices to said set of player computer devices;
initiating playing; and
sending synchronizing signals from said Master computer device over said electronic link to said set of player computer devices during play.

2. A method according to claim 1, in which at least one of said Master and player computer devices has the capability of modifying the music played therein.

3. A method according to claim 2, in which said capability of modifying the music played therein comprises at least one of:
switching a musical effect on or off;
substituting one instrumental voice for another; and
generating musical sounds in response to manual manipulation by a user.

4. A method according to claim 2, in which at least one of said player computer devices has the capability of playing independently of said Master computer device.

5. A method according to claim 2, in which at least one of said player computer devices has at least one percussion sound stored therein and has the capability of playing said percussion sound in response to manual manipulation by a user.

6. A method according to claim 2, in which said capability of modifying the music played therein includes selecting one of at least two stored rhythm data, whereby the user may vary the rhythm of the music.

7. A method according to claim 2, in which said capability of modifying the music played therein includes selecting one of at least two stored melody data, whereby the user may vary the melody being of the music being played.

8. A method according to claim 1, in which at least one of said electronic computer devices is a mobile telephone apparatus.

9. A method according to claim 8, in which at least one of said electronic computer devices is a mobile telephone apparatus containing a first radio frequency transceiver for performing telephonic operations and a second radio frequency transceiver for exchanging messages with other computer devices.

10. A method of playing by a group of users using a group of electronic computer devices a modified musical composition requiring N instrumental voices by a group of at least two users, comprising the steps of:
a) initiating by a first user using a Master computer device a group playing program;
b) selecting a first instrumental voice for playing;
c) assigning the status of Master, Slave or Independent to said first instrumental voice;
d) repeating said steps b) and c) until all N instrumental voices required by said musical composition have been selected;
e) selecting a set of player computer devices for playing said set of instrumental voices;
f) initiating playing; and
g) sending synchronizing signals from said Master computer device over said electronic link to said set of player computer devices during play.

11. A method according to claim 10, in which at least one of said Master and player computer devices has the capability of modifying the music played therein.

12. A method according to claim 11, in which said capability of modifying the music played therein comprises at least one of:
switching a musical effect on or off;
substituting one instrumental voice for another;
generating musical sounds in response to manual manipulation by a user.

13. A method according to claim 11, in which at least one of said player computer devices has the capability of playing independently of said Master computer device.

14. A method according to claim 11, in which at least one of said player computer devices has at least one percussion sound stored therein and has the capability of playing said percussion sound in response to manual manipulation by a user.

15. A method according to claim 11, in which said capability of modifying the music played therein includes selecting one of at least two stored rhythm data, whereby the user may vary the rhythm of the music.

16. A method according to claim 11, in which said capability of modifying the music played therein includes selecting one of at least two stored melody data, whereby the user may vary the melody being of the music being played.

17. A method according to claim 10, in which at least one of said electronic computer devices is a mobile telephone apparatus.

18. A method according to claim 17, in which at least one of said electronic computer devices is a mobile telephone apparatus containing a first radio frequency transceiver for performing telephonic operations and a second radio frequency transceiver for exchanging messages with other computer devices.

19. A method of playing by a group of users using a group of electronic computer devices a modified musical composition requiring N instrumental voices by a group of at least two users, comprising the steps of:
a) initiating by a first user using a Master computer device a group playing program;
b) selecting a first instrumental voice for playing;
c) assigning the status of Master, Slave or Independent to said first instrumental voice;
d) repeating said steps b) and c) until all N instrumental voices required by said musical composition have been selected;
e) posting in a service computer an invitation to apply to play and the specifications of said instrumental voices to be played;
accessing by at least one potential player said service computer;
f) applying by at least one potential player to play said musical composition;
g) selecting by said first user a set of player computer devices and associated potential players for playing said set of instrumental voices;
h) initiating playing; and
i) sending synchronizing signals from said Master computer device over said electronic link to said set of player computer devices during play.

20. A method according to claim 19, in which at least one of said Master and player computer devices has the capability of modifying the music played therein.

21. A method according to claim 20, in which said capability of modifying the music played therein comprises at least one of:
switching a musical effect on or off;
substituting one instrumental voice for another;
generating musical sounds in response to manual manipulation by a user.

22. A method according to claim 20, in which at least one of said player computer devices has the capability of playing independently of said Master computer device.

23. A method according to claim 20, in which at least one of said player computer devices has at least one percussion sound stored therein and has the capability of playing said percussion sound in response to manual manipulation by a user.

24. A method according to claim 20, in which said capability of modifying the music played therein includes selecting one of at least two stored rhythm data, whereby the user may vary the rhythm of the music.

25. A method according to claim 20, in which said capability of modifying the music played therein includes selecting one of at least two stored melody data, whereby the user may vary the melody being of the music being played.

26. A method according to claim 19, in which at least one of said electronic computer devices is a mobile telephone apparatus.

27. A method according to claim 25, in which at least one of said electronic computer devices is a mobile telephone apparatus containing a first radio frequency transceiver for performing telephonic operations and a second radio frequency transceiver for exchanging messages with other computer devices.
